(19) United States
(12) Patent Application Publication
(10) Pub. No.: US 2013/0072418 A1
(43) Pub. Date: Mar. 21, 2013

(54) METHOD FOR TREATING SCALES

(71) Applicants: Nobuo Ishihara, Minato-ku (JP); Hirokazu Miyata, Minato-ku (JP); Yasuhiko Shoda, Minato-ku (JP); Hiroyuki Fujiwara, Minato-ku (JP)

(72) Inventors: Nobuo Ishihara, Minato-ku (JP); Hirokazu Miyata, Minato-ku (JP); Yasuhiko Shoda, Minato-ku (JP); Hiroyuki Fujiwara, Minato-ku (JP)

(73) Assignee: MITSUBISHI HEAVY INDUSTRIES, LTD., Tokyo (JP)

(21) Appl. No.: 13/582,272

(22) PCT Filed: Jan. 31, 2011
(86) PCT No.: PCT/JP2011/051851

§ 371 Date: Nov. 21, 2012

(30) Foreign Application Priority Data
May 28, 2010 (JP) 2010-122253

(51) Int. Cl. C11D 7/26

(52) U.S. Cl. CPC C11D 7/265
USPC 510/253

(57) ABSTRACT

Provided is a method for treating scales (101) that have formed on the outer surface of a heat-conducting tube (111) and in a hole (112a) of a tube support plate (112) etc. of a steam generator of a nuclear power plant. The scales (101) are embrittled and also converted to a porous state by bringing the scales (101) into contact with a treatment solution, which contains 0.5 to 3.5 wt % of an organic acid and is at a pH of 2 to 3.5, for 2 to 30 days at 20° C. to 40° C.

### TECHNICAL FIELD

The present invention relates to a method for treating scale made of a metal oxide formed on a metal member. Particularly, the present invention is effective when applied for treating scale made of iron oxide formed on a secondary side of a boiler, a steam generator, and the like of nuclear power plant facilities.

### BACKGROUND ART

In a steam generator of nuclear power plant facilities such as a pressurized water reactor (PWR) for example, while the operation is continued, scale (films) 101 made of iron oxide gradually adheres, as shown in FIGS. 1, 2: to an outer surface of a heat transfer tube 111 through the inside of which a heating fluid flows so as to heat and vaporize water coming into contact with an outer surface of the heat transfer tube 111; and around hole portions 112a of a tube support plate 112 which supports the heat transfer tube 111 and the hole portions 112a of which allows water and steam to flow therethrough.

The adhesion and deposition of such scale 101 lower the water boiling efficiency at the outer surface of the heat transfer tube 111, while, at the hole portions 112a of the tube support plate 112, inhibiting the flows of water and steam at the hole portions 112a.

Against this problem, conventionally, after a certain period of operation, the operation is stopped temporarily, and ethylenediaminetetraacetic acid (EDTA) is supplied. The ethylenediaminetetraacetic acid (EDTA) is then kept in contact with an outer surface side (secondary side) of the heat transfer tube 111 in the steam generator for approximately 1 to 2 days while being heated at 70 to 90° C. Thus, the scale 101 is subjected to a cleaning process (Advanced Scale Conditioning Agent (ASCA) process).

### CITATION LIST

### Patent Literature

Patent Literature 1: Japanese Patent Application Publication No. Hei 10-253290
Patent Literature 2: Japanese Patent Application Publication No. 2001-031998
Patent Literature 3: Japanese Patent Application Publication No. 2003-176997

### SUMMARY OF INVENTION

### Technical Problem

Nevertheless, recently, there have been increasing demands for further recoveries of the water boiling efficiency, the flows of water and steam, and so forth than the conventional method as described above.

### Solution to Problem

To solve the above-described problem, a method for treating scale according to the present invention is a method for treating scale made of a metal oxide formed on a metal member, the method characterized by comprising the step of bringing a treatment solution containing 0.5 to 3.5% by weight of an organic acid and having a pH of 2 to 3.5 into contact with the scale on the metal member at 20 to 40° C. for 2 to 30 days.

Moreover, a method for treating scale according to the present invention is the above-described method for treating scale, characterized in that the scale mainly contains iron oxide.

Further, a method for treating scale according to the present invention is the above-described method for treating scale, characterized in that

the metal member is any one of a heat transfer tube and a tube support plate in a steam generator, and

the scale is formed on an outer surface of the heat transfer tube or formed between the heat transfer tube and the tube support plate.

### Advantageous Effects of Invention

The method for treating scale according to the present invention is capable of making scale into brittle and porous state. Thus, when the method is applied to a treatment for an outer surface side (secondary side) of a heat transfer tube in a steam generator of nuclear power plant facilities such as a pressurized water reactor (PWR) for example, scale formed on the outer surface of the heat transfer tube in the steam generator demonstrates a function of a boiling stone; additionally, most parts of scale formed on narrow hole portions of a tube support plate in the steam generator are fragmented and fall off from the hole portions by vibration at the starting of the nuclear power plant facilities, water flow, or the like. Hence, during the power generation operation of the nuclear power plant facilities, it is possible to efficiently boil water that is in contact with the outer surface side of the heat transfer tube in the steam generator. Moreover, water and steam can flow smoothly through the hole portions of the tube support plate. Thus, further recoveries of the water boiling efficiency, the flows of water and steam, and so forth are achieved than the conventional method.

### BRIEF DESCRIPTION OF DRAWINGS

FIG. 1 is an enlarged cross-sectional view of partially extracted portions of a tube support plate and a heat transfer tube in a steam generator of nuclear power plant facilities operated for a certain period.

FIG. 2 is a cross-sectional view taken along the line II-II and seen in a direction of the arrows in FIG. 1.

FIG. 3 is a graph illustrating a relationship between the temperature of a treatment solution and the amount of a test piece corroded in a test conducted to verify effects of a method for treating scale according to the present invention.

FIG. 4 is a graph illustrating a relationship between the treatment period and the pore formation position in a test conducted to verify effects of the method for treating scale according to the present invention.

FIG. 5 is a graph illustrating a relationship between the treatment period and the fragmentation (fall-off) percentage in the test conducted to verify effects of the method for treating scale according to the present invention.

FIG. 6 is a bubble graph illustrating a relationship between various acid concentrations and pHs, and the pore formation position in a test conducted to verify effects of the method for treating scale according to the present invention.

FIG. 7 is a bubble graph illustrating a relationship between various acid concentrations and pHs, and the fragmentation (fall-off) percentage in the test conducted to verify effects of the method for treating scale according to the present invention.

### DESCRIPTION OF EMBODIMENTS

### Main Embodiment

Hereinafter, a main embodiment of a method for treating scale according to the present invention will be described. However, the present invention is not limited only to the embodiment described below.

The method for treating scale according to the embodiment is a method for treating scale made of a metal oxide formed on a metal member, the method including a step of bringing a treatment solution containing 0.5 to 3.5% by weight (preferably 0.5 to 2% by weight, optimally 1 to 2% by weight) of an organic acid and having a pH of 2 to 3.5 (preferably pH of 2.5 to 3.5, optimally pH of 3) into contact with the scale on the metal member at 20 to 40° C. (preferably 25 to 35° C.) for 2 to 30 days (preferably for 5 to 15 days).

Here, if the scale mainly contains iron oxide, the method is effective. Particularly, if the metal member is a heat transfer tube or a tube support plate in a steam generator of nuclear power plant facilities such as a pressurized water reactor (PWR) while the scale is formed on an outer surface of the heat transfer tube or formed between the heat transfer tube and the tube support plate, the method is quite effective.

Examples of the organic acid include acetic acid, propionic acid, malic acid, glycolic acid, ascorbic acid, malonic acid, oxalic acid, citric acid, lactic acid, succinic acid, tartaric acid, formic acid, hydroxyacetic acid, monochloroacetic acid, dichloroacetic acid, chloropropionic acid, thiomalic acid, thioglycolic acid, and the like. Particularly, a mixture of malonic acid, glycolic acid, and ascorbic acid is preferable.

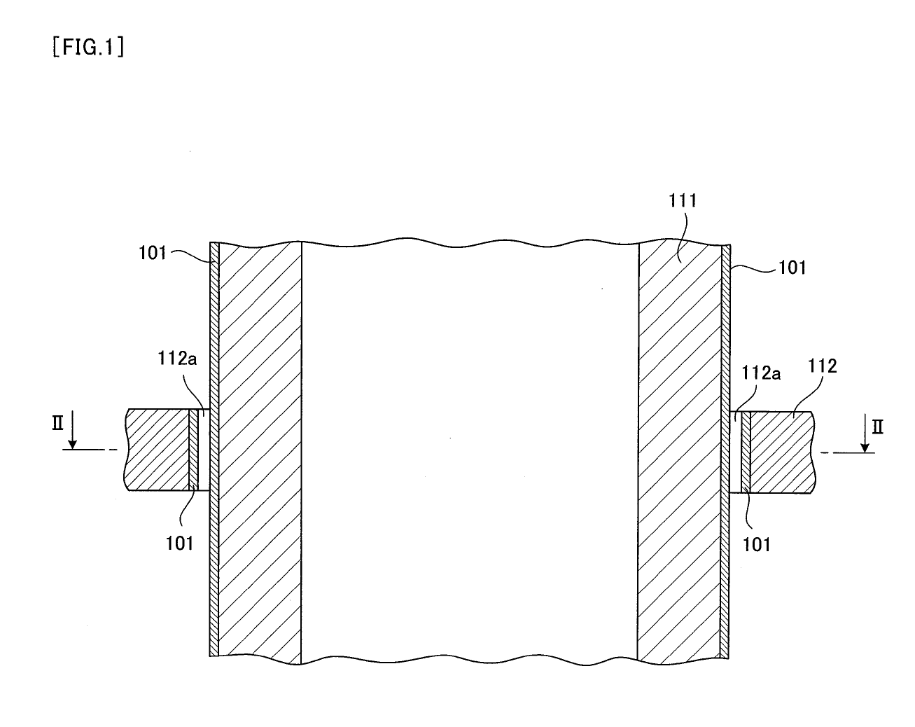

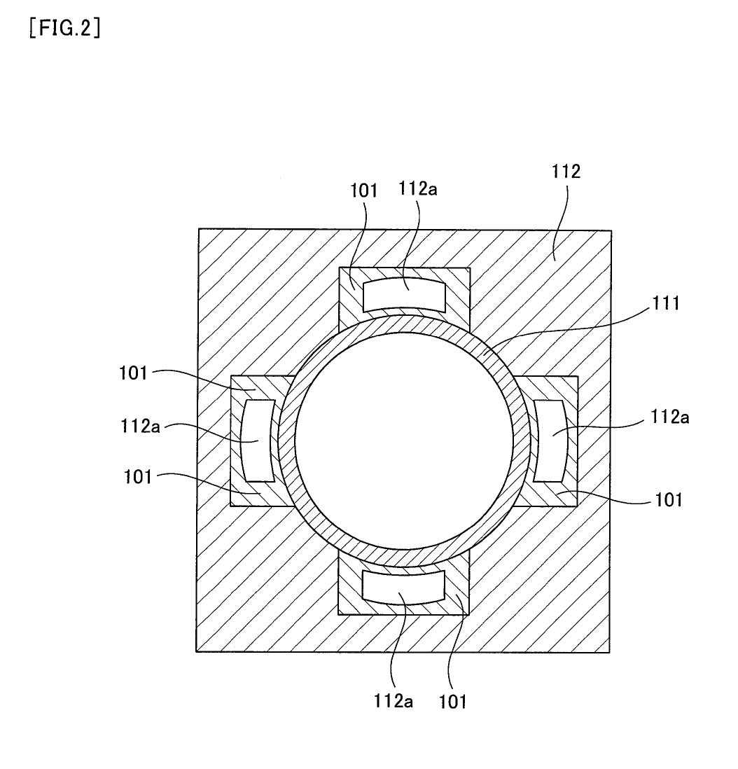

When an outer surface side (secondary side) of a heat transfer tube in a steam generator of nuclear power plant facilities such as a pressurized water reactor (PWR) for example is treated by such a method for treating scale, scale 101 mainly made of iron oxide formed on the outer surface of the heat transfer tube 111 and scale 101 mainly made of iron oxide formed around hole portions 112a of the tube support plate 112 as shown in FIGS. 1, 2 are made into brittle and porous states.

Thus, the scale 101 formed on the outer surface of the heat transfer tube 111 in the steam generator demonstrates a function of a boiling stone. Additionally, most parts of the scale 101 formed around the narrow hole portions 112a of the tube support plate 112 in the steam generator are fragmented and fall off therefrom by vibration at the starting of the nuclear power plant facilities, water flow, or the like.

Hence, during the power generation operation of the nuclear power plant facilities, it is possible to efficiently boil water that is in contact with the outer surface side of the heat transfer tube 111 in the steam generator. Moreover, water and steam can flow smoothly through the hole portions 112a of the tube support plate 112.

In other words, conventionally, the scale 101 has been treated aiming at dissolution and removal as completely as possible. In contrast, the embodiment does not aim at complete dissolution and removal of the scale 101, but the scale 101 is intentionally left in brittle and porous states. Accordingly, the scale 101 formed on the outer surface of the heat transfer tube 111 is provided with a function of a boiling stone. Moreover, most parts of the scale 101 formed around the narrow hole portions 112a of the tube support plate 112 are caused to fall off from the hole portions 112a during power generation operations.

Thus, the embodiment easily achieves further recoveries of the water boiling efficiency, the flows of water and steam, and so forth than the conventional method (ASCA process).

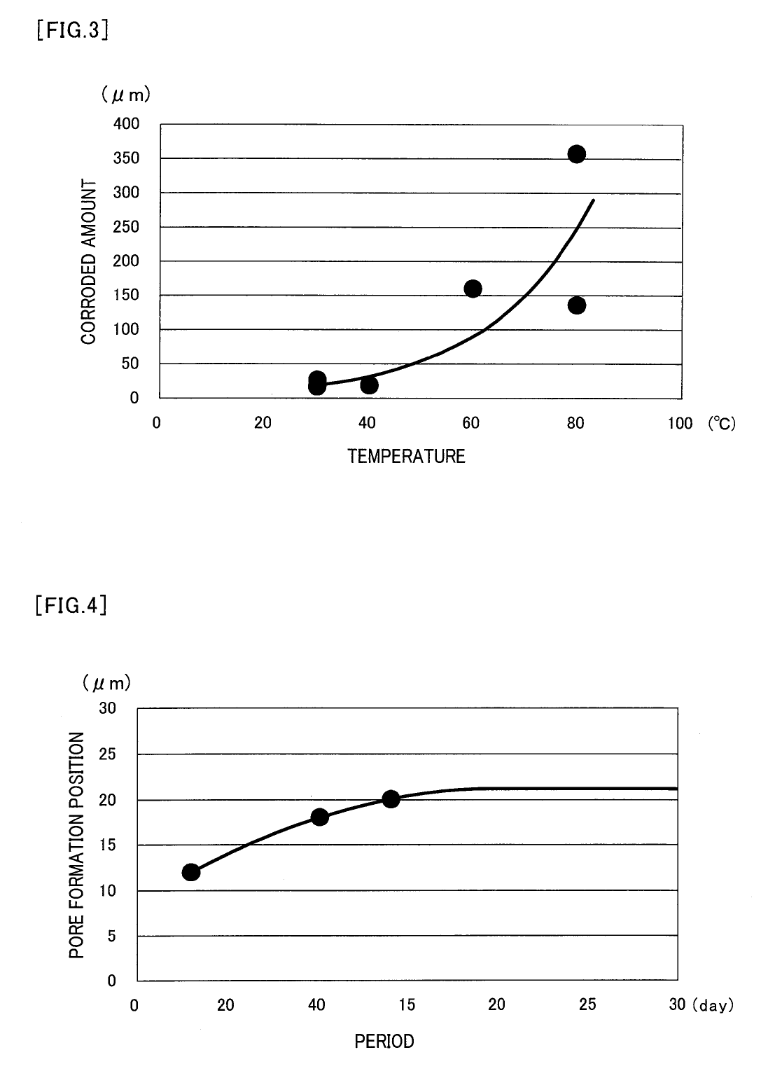

Now, description will be given of the results of tests conducted to verify effects of the method for treating scale according to the present invention shown in FIGS. 3 to 8.

A test piece made of carbon steel was immersed in a treatment solution (organic acid: a mixture of malonic acid, glycolic acid, and ascorbic acid; concentration: 1% by weight; pH: 3.0) for the treatment (period: 14 days). FIG. 3 is a graph illustrating a relationship between the temperature of the treatment solution and the amount of the test piece corroded in the treatment. As seen from FIG. 3, the amount of the test piece corroded rapidly increases from the temperature of the treatment solution exceeding 40° C. This suggests that the treatment need to be performed at a temperature of 40° C. or below to ensure the maintainability of the base material.

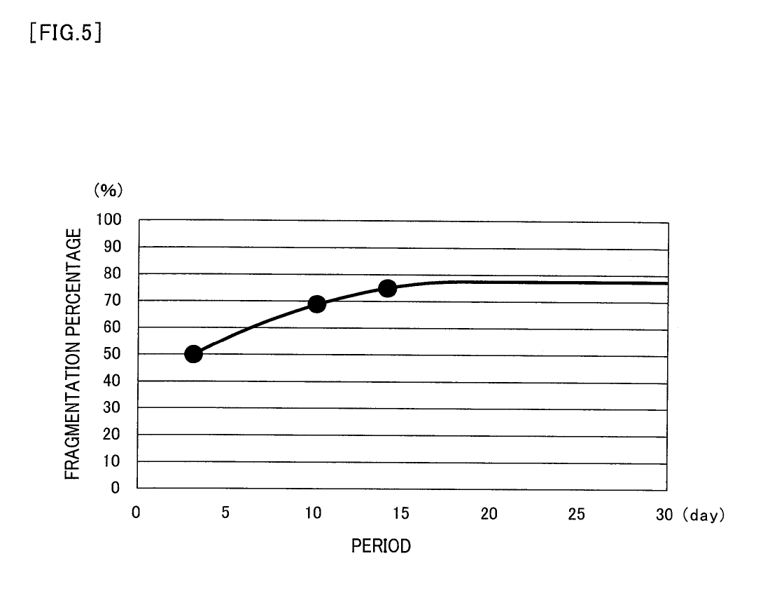

Scale made of iron oxide (thickness: approximately 100 μm) was immersed (temperature: 30° C.) in a treatment solution (organic acid: a mixture of malonic acid, glycolic acid, and ascorbic acid; concentration: 1% by weight; pH: 3.0) for the treatment. FIGS. 4, 5 are graphs illustrating relationships between the treatment period and the pore formation position (FIG. 4) and between the treatment period and the fragmentation (fall-off) percentage (FIG. 5) in the treatment. Note that the pore formation position refers to a distance (depth) from the surface of scale to a position where the porosity of the scale is 15%, and the fragmentation (fall-off) percentage refers to a percentage of scale fallen off. As seen from FIGS. 4, 5, both of the pore formation position and the fragmentation (fall-off) percentage reach the plateaus in the treatment period of around 15 days. This suggests that the treatment for around 15 days be the most effective.

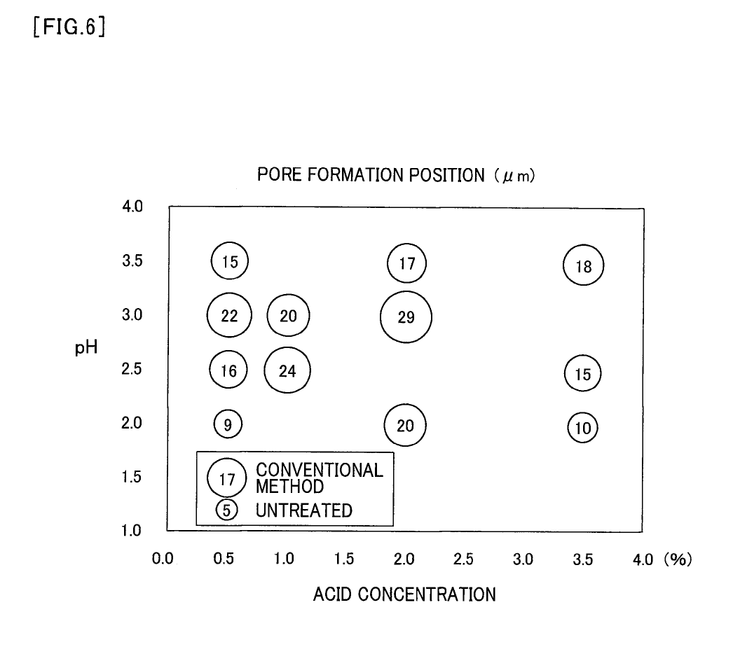

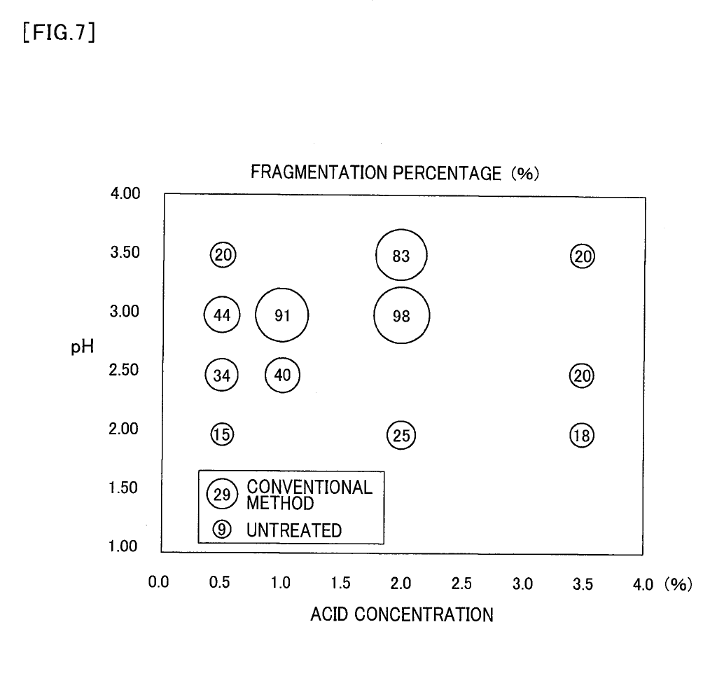

Scale made of iron oxide (thickness: approximately 100 μm) was immersed (temperature: 30° C.) in treatment solutions (organic acid: a mixture of malonic acid, glycolic acid, and ascorbic acid) of various acid concentrations and pHs for the treatment (period: 14 days). FIGS. 6, 7 are bubble graphs illustrating relationships between various acid concentrations and pHs, and the pore formation position (FIG. 6) and between various acid concentrations and pHs, and the fragmentation (fall-off) percentage (FIG. 7). As seen from FIGS. 6, 7, the followings were verified. Specifically, treatment solutions having an acid concentration of 0.5 to 3.5% by weight at a pH of 2 to 3.5 can increase the pore formation position and the fragmentation (fall-off) percentage higher than those of the untreated case. Particularly, treatment solutions having an acid concentration of 0.5 to 2% by weight and a pH of 2.5 to 3.5 can increase the pore formation position and the fragmentation (fall-off) percentage higher than those obtained by the conventional method (ASCA process). A treatment solution having an acid concentration of 2% by weight and a pH of 3 can increase the pore formation position and the fragmentation (fall-off) percentage the most.

### Other Embodiments

Note that, in the above-described embodiment, the description has been given of a case of treating the scale 101 formed on the surface of the secondary side of the heat transfer tube 111 in the steam generator of nuclear power plant facilities. However, the present invention is not limited thereto. The present invention is applicable, as long as scale made of a metal oxide formed on a metal member is treated including a case where scale mainly containing iron oxide is formed on boilers and the like, for example.

### INDUSTRIAL APPLICABILITY

A method for treating scale according to the present invention is capable of making scale into brittle and porous states. Thus, when the method is applied to a treatment for an outer surface side (secondary side) of a heat transfer tube in a steam generator of nuclear power plant facilities such as a pressurized water reactor (PWR) for example, this leads to achievement in further recoveries of the water boiling efficiency, the flows of water and steam, and so forth than the conventional method. Therefore, the method is industrially quite beneficially usable.

### REFERENCE SIGNS LIST

101 scale
111 heat transfer tube
112 tube support plate
112a hole portion

1. A method for treating scale made of a metal oxide formed on a metal member, the method comprising the step of bringing a treatment solution containing 0.5 to 3.5% by weight of an organic acid and having a pH of 2 to 3.5 into contact with the scale on the metal member at 20 to 40° C. for 2 to 30 days.

2. The method for treating scale according to claim 1, wherein the scale mainly contains iron oxide.

3. The method for treating scale according to claim 2, wherein
the metal member is any one of a heat transfer tube and a tube support plate in a steam generator, and
the scale is formed on an outer surface of the heat transfer tube or formed between the heat transfer tube and the tube support plate.
